(19) United States
(12) Patent Application Publication
(10) Pub. No.: US 2014/0351018 A1
(43) Pub. Date: Nov. 27, 2014

(54) SYSTEM AND METHOD FOR BENCHMARKING ENERGY USAGE

(71) Applicant: MASTERCARD INTERNATIONAL INCORPORATED, Purchase, NY (US)

(72) Inventor: Jason A. Feldman, New York, NY (US)

(73) Assignee: MASTERCARD INTERNATIONAL INCORPORATED, Purchase, NY (US)

(21) Appl. No.: 13/901,751

(22) Filed: May 24, 2013

(51) Int. Cl. G06Q 30/02

(52) U.S. Cl. CPC G06Q 30/0204
USPC 705/7.33

(57) ABSTRACT

A system and method is disclosed for benchmarking and comparing energy consumption of a particular consumer to a relevant set of comparison consumers using a system that maintains a database of payment information. Using the payment information and publicly available information, the system identifies comparison consumers, dwelling addresses, calculates energy consumption and generates consumer profiles containing dwelling, location and demographic characteristics. The system also compares profiles to identify “look-a-like” consumers and analyzes energy consumption to determine a benchmark and compares a particular consumer's consumption to the benchmark. The system also generates reports detailing the comparison and provides the report to consumers. The system thereby accurately measures on a national scale whether a particular consumer's monthly energy consumption and payments are above/below/on-target with very specific look-a-like consumers and provides a solution for consumers/business to understand the accuracy of their invoice and if their structure has outsized consumption.

### TECHNICAL FIELD OF THE INVENTION

This patent application relates generally to the field of monitoring energy use, and more particularly to energy use benchmarking, comparison and reporting.

### BACKGROUND OF THE INVENTION

Currently consumers and businesses pay for the energy consumed while using their homes or businesses without an understanding of how their energy consumption compares to others. While consumers may see whether their usage goes up or down on a month to month basis, most are unable to put this usage in context of other consumers.

It is known in the prior art to report a consumer's resource usage as compared to the resource usage of his neighbors. In some cases, the consumer is compared to the average resource usage in his particular geographic area. The problem with such a comparison, however, is that numerous factors affect energy use and, in all likelihood, one consumer's home energy use will be different than many of the other homes within his geographic area. Thus, the consumer might view the comparison as unfair. If the consumer does not believe the comparison is legitimate, then he is unlikely to change his resource conservation practices based on the comparison. To address this problem, prior art methods select neighbors that have similar characteristics to the consumer. This methodology works adequately for areas in which homes share many common characteristics. Such a methodology, however, does not work as well for areas where factors other than generic geography should be considered to accurately determine similar consumers.

To the extent that there might exist services that take a more granular approach to determining comparable consumers, such services might consider characteristics such as dwelling type, home size, home age, location, number of occupants and age of occupants. However, these particular characteristics are inadequate for comparison purposes because they fail to take into account demographic characteristics.

In addition, these services are lacking in that the number of data points for comparison is small since the data points are limited to a particular geographical area. Because current comparison services derive their usage and consumer related data directly from energy providers, the amount of data is limited to only participating users or participating energy providers. This limits the sample data to the geographical areas serviced by the participating energy providers. Currently, the art lacks an ability to generate usage comparisons over a broad sample set that is not geographically limited. Moreover, there is a lack of ability to generate such comparisons independent of the actual consumption data provided by the energy supplier.

It is desirable for a system and method to provide energy consumption comparison and benchmarking services using sample data that is free of geographical scope constraints. Furthermore it is desirable for an energy consumption comparison and benchmarking system that is independent of (i.e., not dependant) on participating energy providers to provide the actual consumption data.

It is with respect to these and other considerations that the disclosure made herein is presented.

### SUMMARY OF THE INVENTION

According to a first aspect, a computer implemented method is provided for benchmarking and comparing energy consumption of a particular consumer to a relevant set of comparison consumers yet to be identified. The particular consumer has a profile, which includes a plurality of data points relating to the particular consumer and the particular consumer's dwelling. The method includes, identifying the relevant set of comparison consumers using a processor configured by code by applying an algorithm that, for each of the comparison consumers, compares one or more of the particular consumer's data points to a particular comparison consumer's one or more corresponding data points. The one or more corresponding data points are determined from at least a database of payment data and a database of dwelling characteristic data. In addition, the particular comparison consumer being compared is added to the relevant set when the one or more corresponding data points match the one or more data points. The method also includes determining a benchmark energy consumption using the configured processor by applying an algorithm that, for each of the comparison consumers in the relevant set, calculates the respective energy consumption using the database of payment data and the database of dwelling characteristic data. In addition, the method includes calculating, with the configured processor, the particular consumer's energy consumption using the database of payment data and the database of dwelling characteristic data. Furthermore, the method includes generating, with the configured processor, an energy consumption report, by applying an algorithm that compares the particular consumer's energy consumption to the benchmark energy consumption and providing the energy consumption report to the particular consumer.

The method can also include generating the particular consumer's profile using the processor configured by code executing therein. A profile is generated by retrieving the particular consumer's payment data from the payment database over a computer network and retrieving the particular consumer's demographic data. In addition, the method includes analyzing the payment data or the demographic data to identify an address for the dwelling, retrieving dwelling characteristic data over a computer network from the dwelling characteristic database. The dwelling characteristic data can include dwelling data, location data and utility rate data. The method also includes, analyzing the payment data, the demographic data and the dwelling characteristic data in order to identify the plurality of data points and create the particular consumer's profile.

According to another aspect, a system is provided for benchmarking and comparing energy consumption of a particular consumer to a relevant set of comparison consumers yet to be identified from a database of payment data and a database of demographic data and a database of dwelling characteristic data. The system has one or more processors configured to interact with a computer-readable storage medium and execute one or more modules stored on the storage medium. The modules include a database module that configures the processor to receive payment data from the database of payment data, and demographic data from a database of demographic data. The modules also include a consumer analysis module configured to, retrieve dwelling characteristic data relating to the particular consumer and analyze the dwelling characteristic data, payment data and demographic data in order to generate a profile including a plurality of data points relating to the particular consumer and the particular consumer's dwelling. The modules also include a comparison module configured to identify the relevant set of comparison consumers from at least the database of payment data; calculate the energy consumption for the particular consumer; calculate the energy consumption for the relevant set of comparison consumers and compare the energy consumption of the particular consumer to the energy consumption of the relevant set of comparison consumers. The modules also include a reporting module configured to generate a comparison report and provide the comparison report to the particular consumer.

These and other aspects, features, and advantages can be appreciated from the accompanying description of certain embodiments of the invention and the accompanying drawing figures and claims.

### BRIEF DESCRIPTION OF THE DRAWINGS

FIG. 1 is a high-level diagram illustrating an exemplary configuration of a system for benchmarking energy usage in accordance with at least one embodiment disclosed herein;

FIG. 2 is a block diagram illustrating an exemplary configuration of a system for benchmarking energy usage in accordance with at least one embodiment disclosed herein; and

FIG. 3 is a flow diagram illustrating a routine for benchmarking energy usage in accordance with at least one embodiment disclosed herein.

### DETAILED DESCRIPTION OF CERTAIN EMBODIMENTS OF THE INVENTION

By way of overview and introduction, various systems and methods are described herein that facilitate and enable the benchmarking of energy usage. The systems and methods have the end goal of creating a benchmarking tool for consumers (e.g., individuals and businesses) to assess the energy consumption of the consumer's dwelling (e.g., home or business space). The system achieves this by maintaining a database of payment data and using each consumer's payment/transaction data to identify the consumer's demographic details, an address for one or more dwellings and a history of payments made to energy providers. The system is configured such that it collects a variety of different types of publicly available data including building codes, certificate of occupancy data, weather data, and utility rates (e.g., electricity, natural gas and oil rates). The personal and public information regarding dwelling and location characteristics can be compiled by an embodiment of the system into a profile for each consumer that includes dwelling characteristics, location related characteristics and personal/demographic characteristics. In addition, using payment data and utility rate information a suitably configured system can also determine each consumer's energy consumption. Likewise, such a system can compare profiles to identify “look-a-like” consumers and analyze energy consumption to determine a benchmark and compare a particular consumer's consumption to the benchmark. The system can also generate reports detailing the comparison and provide the report to consumers. In addition, the system can also provide consumers with further analysis and suggestions regarding how best to improve energy consumption as a result of the comparison. According to a salient aspect of the invention, the combination and processing of this data will accurately measure on a national scale whether a particular consumer's monthly energy consumption and payments are above/below/on-target with very specific look-a-like consumers across the U.S. This system and method provides a solution for consumers/business to understand (a) the accuracy of their invoice; and (b) if their structure has outsized consumption.

The following detailed description is directed to systems and methods for benchmarking and comparing energy usage. The referenced systems and methods are now described more fully with reference to the accompanying drawings, in which one or more illustrated embodiments and/or arrangements of the systems and methods are shown. The systems and methods are not limited in any way to the illustrated embodiments and/or arrangements as the illustrated embodiments and/or arrangements described below are merely exemplary of the systems and methods, which can be embodied in various forms, as appreciated by one skilled in the art. Therefore, it is to be understood that any structural and functional details disclosed herein are not to be interpreted as limiting the systems and methods, but rather, are provided as a representative embodiment and/or arrangement for teaching one skilled in the art one or more ways to implement the systems and methods. Accordingly, aspects of the present systems and methods can take the form of an entirely hardware embodiment, an entirely software embodiment (including firmware, resident software, micro-code, etc.), or an embodiment combining software and hardware. One of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer. Furthermore, the terms and phrases used herein are not intended to be limiting, but rather, are to provide an understandable description of the systems and methods.

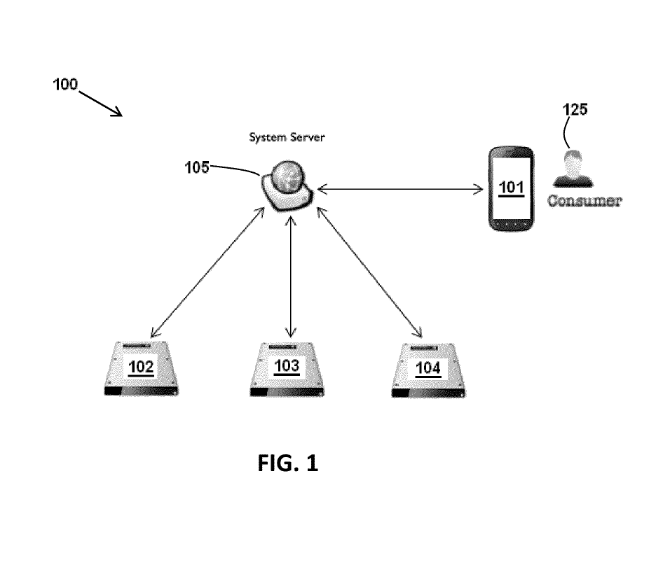

An exemplary system is shown as a block diagram in FIG. 1 which is a high-level diagram illustrating an exemplary configuration of an energy consumption benchmarking and comparison system 100. In one arrangement, the system consists of a system server 105 communicatively coupled to at least one consumer device 101 and at least one dwelling characteristic database 102 and at least one payment database 103 and at least one demographic information database 104. It should be understood that system server 105 can be practically any computing device and/or data processing apparatus capable of being configured to implement functionality and/or methods described herein.

Consumer device 101 can be configured to collect (and/or display) information from one or more consumers, including a particular consumer 125, communicate the information to the system server 105 and receive information from the system server. Dwelling characteristic database 102 can be configured to receive information from the system server and provide publicly available information to the system server 105. Payment database 103 can be configured to receive information from the system server and provide payment data relating to one or more consumers. Demographic database 104 can be configured to receive information from the system server and provide demographic data relating to one or more consumers. It should be understood that consumer device can be any computing device and/or data processing apparatus capable of embodying the systems and/or methods described herein, including, but not limited to, a personal computer, tablet computer or smart phone device. It should be understood that dwelling characteristic database, payment database and demographic information database, can be any computing device and/or data processing apparatus capable of embodying the systems and/or methods described herein, including, but not limited to, a personal computer, server computer and the like.

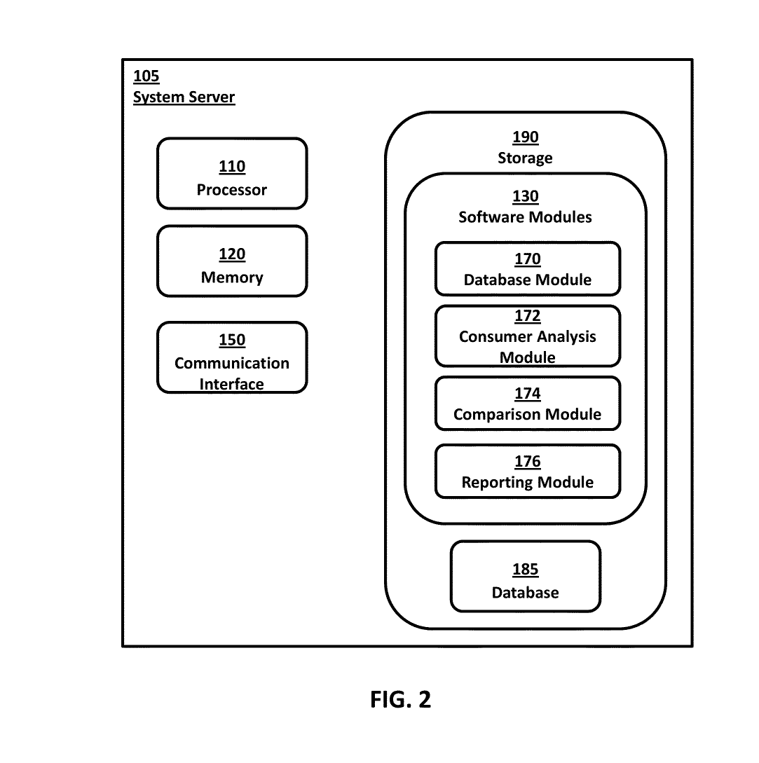

In reference to FIG. 2, system server 105 of energy consumption benchmarking and comparison system 100 is arranged with various hardware and software components that serve to enable operation of the system, including a processor 110, memory 120, storage 190 and a communication interface 150. Processor 110 serves to execute software instructions that can be loaded into memory 120. Processor 110 can be a number of processors, a multi-processor core, or some other type of processor, depending on the particular implementation.

Preferably, memory 120 and/or storage 190 are accessible by processor 110, thereby enabling processor 110 to receive and execute instructions stored on memory 120 and/or on storage 190. Memory 120 can be, for example, a random access memory (RAM) or any other suitable volatile or non-volatile computer readable storage medium. In addition, memory 120 can be fixed or removable. Storage 190 can take various forms, depending on the particular implementation. For example, storage 190 can contain one or more components or devices such as a hard drive, a flash memory, a rewritable optical disk, a rewritable magnetic tape, or some combination of the above. Storage 190 also can be fixed or removable or remote such as cloud based data storage systems.

One or more software modules 130 are encoded in storage 190 and/or in memory 120. The software modules 130 can comprise one or more software programs or applications having computer program code or a set of instructions executed in processor 110. Such computer program code or instructions for carrying out operations for aspects of the systems and methods disclosed herein can be written in any combination of one or more programming languages. The program code can execute entirely on system server 105, partly on system server 105, as a stand-alone software package, partly on system server 105 and partly on a remote computer/device such as consumer device 101, or any computing devices maintaining the dwelling characteristic database 102, payment database 103 and demographic information database 104 or entirely on the remote computer/device. In the latter scenario, the remote computer can be connected to system server 105 through any type of network, including a local area network (LAN) or a wide area network (WAN), or the connection can be made to an external computer (for example, through the Internet using an Internet Service Provider).

Preferably, included among the software modules 130 is a database module 170, a consumer analysis module 172, a comparison module 174, and a reporting module 176 that are executed by processor 110. During execution of the software modules 130, the processor 110 configures the system server 105 to perform various operations relating to the benchmarking and comparing energy consumption, as will be described in greater detail below.

It can also be said that the program code of software modules 130 and one or more computer readable storage devices (such as memory 120 and/or storage 190) form a computer program product that can be manufactured and/or distributed in accordance with the present invention, as is known to those of ordinary skill in the art.

It should be understood that in some illustrative embodiments, one or more of software modules 130 can be downloaded over a network to storage 190 from another device or system via communication interface 150 for use within the energy consumption benchmarking and comparison system 100. In addition, it should be noted that other information and/or data relevant to the operation of the present systems and methods (such as database 185) can also be stored on storage 190, as will be discussed in greater detail below.

Also preferably stored on storage 190 is database 185. As will be described in greater detail below, database 185 contains and/or maintains various data items and elements that are utilized throughout the various operations of energy consumption benchmarking and comparison system 100. The information stored in database 185 can include, but is not limited to, profiles, payment data, dwelling characteristic data, and demographic data relating to consumers, as will be described in greater detail herein. It should be noted that although database 185 is depicted as being configured locally to system server 105, in certain implementations, database 185 and/or various of the data elements stored therein can be located remotely (such as on a remote device or server—not shown) and connected to system server 105 through a network in a manner known to those of ordinary skill in the art.

Communication interface 150 is also operatively connected to the processor 110 and can be any interface that enables communication between the system server 105 and external devices, machines and/or elements including remote devices 101, 102, 103 and 104. Preferably, communication interface 150 includes, but is not limited to, a modem, a Network Interface Card (NIC), an integrated network interface, a radio frequency transmitter/receiver (e.g., Bluetooth, cellular, NFC), a satellite communication transmitter/receiver, an infrared port, a USB connection, and/or any other such interfaces for connecting system server 105 to other computing devices and/or communication networks, such as private networks and the Internet. Such connections can include a wired connection or a wireless connection (e.g., using the IEEE 802.11 standard) though it should be understood that communication interface 150 can be practically any interface that enables communication to/from the system server 105.

At various points during the operation of energy consumption benchmarking and comparison system 100, system server 105 can communicate with one or more computing devices, such as devices 101, 102, 103, 104, each of which will be described in greater detail herein. Such computing devices transmit and/or receive data to/from system server 105, thereby preferably initiating, maintaining, and/or enhancing the operation of the energy consumption benchmarking and comparison system 100, as will be described in greater detail below.

It should be understood that any of the computing devices 101, 102, 103, 104 can be in direct communication with system server 105, indirect communication with system server 105, and/or can be communicatively coordinated with system server 105 through a computer network 160 such as the Internet.

It should be noted that while FIG. 1 depicts energy consumption benchmarking and comparison system 100 with respect to a consumer device 101, dwelling characteristic database 102, payment database 103, demographic information database 104, it should be understood that any number of such computing devices 101 and/or databases 102, 103 and 104 can interact with the energy consumption benchmarking and comparison system 100 in the manner described herein. It should also be noted that while FIG. 1 depicts an energy consumption benchmarking and comparison system with respect to a particular consumer 125, it should be understood that any number of consumers can interact with the energy consumption benchmarking and comparison system in the manner described herein. It should be further understood that a substantial number of the operations described herein are initiated by and/or performed in relation to such computing devices. For example, as referenced above, such computing devices can execute applications and/or viewers that request and/or receive data from system server 105, substantially in the manner described in detail herein.

It should be further understood that while the various computing devices and machines referenced herein, including but not limited to, system server 105, consumer device 101, dwelling characteristic database 102, payment database 103 and demographic information database 104 are referred to herein as individual/single devices and/or machines, in certain implementations the referenced devices and machines, and their associated and/or accompanying operations, features, and/or functionalities can be arranged or otherwise employed across any number of devices and/or machines, such as over a network connection, as is known to those of skill in the art.

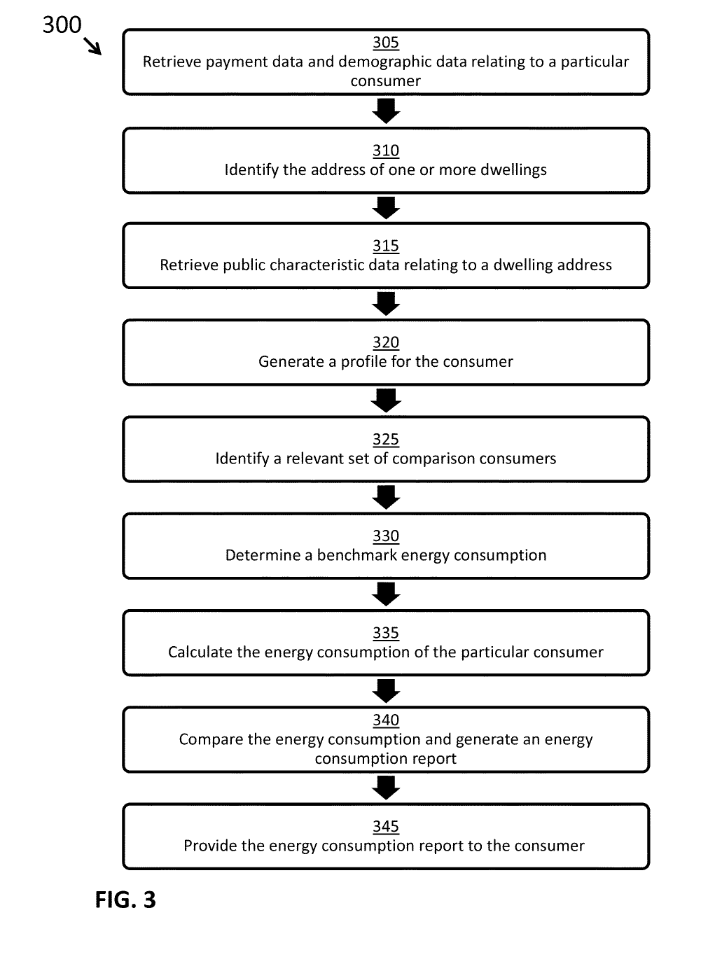

The operation of the energy consumption benchmarking and comparison system 100 and the various elements and components described above will be further appreciated with reference to the method for benchmarking and comparing energy consumption as described below, in conjunction with FIG. 3.

Turning now to FIG. 3, a flow diagram illustrates a routine 300 for benchmarking and comparing energy consumption of a consumer in accordance with at least one embodiment disclosed herein. It should be appreciated that more or fewer operations can be performed than shown in the figures and described herein. These operations can also be performed in a different order than those described herein.

The process begins at step 305, in which processor 110 executing one or more of software modules 130, including, preferably database module 170, configures system server 105 to retrieve payment data and demographic data relating to a particular consumer. The particular consumer being an individual or business type customer who makes payments for the energy consumed by one or more dwellings (e.g., a home or business location and the like).

At some point prior to step 305, the particular consumer 125 using a consumer device 101 can provide payment related information to the system. For example, this can be done by connecting to system server 105 using consumer device 101 and providing payment information such as a credit card number, banking information, ACH payment information and the like. It should be understood that, alternatively, the particular consumer can simply provide a few key pieces of personal information such as a name and/or social security number and grant permission for the system server 105 to access his or her payment data. In addition, the particular consumer could be automatically included in the system by virtue of having a payment card issued by a participating card issuer or having credit history record on file with a credit bureau. In addition, a consumer can be automatically included from utility usage records provided by a utility company. Using either personal information or payment information, system server 105, via a transaction processing company, card issuer, credit bureau and the like, can automatically retrieve payment data for the particular consumer. Any automatic inclusion of a consumer's information would be subject to applicable data privacy and data usages laws.

Payment data can include, but is not limited to, the particular consumer's transaction history using a variety of payment methods such as a credit card, a debit card, a prepaid card, a gift card, bank account billpay service, ACH payment, a TSM account, or a combination of the foregoing. The payment transaction history can be retrieved from a first data source, such as payment database 103, which can be operated by a payment service provider, such as MasterCard International Incorporated. System server 105 can then analyze the transaction history to identify payments made to energy providers. Energy providers can include any provider of energy and resources, including but not limited to, electricity/utility companies, natural gas providers and oil suppliers. In analyzing the transaction history, the system server can identify the name and location of the energy providers and associate the energy providers with the payments made by the consumer.

System server can also retrieve demographic data relating to the consumer that can include, but is not limited to, the particular consumer's name, age, address, education level, occupation, and family-related data, such as marital status and number of children. Demographic data can be determined by analyzing the payment data retrieved from the payment database 102. Alternatively, or in addition, demographic data can be retrieved from a demographic information database 104. It should be understood that the payment database and demographic information database, are not necessarily distinct sources and can be operated by the same payment service provider. It should also be understood that demographic data can be obtained from third party providers of such information such as a credit reporting agency, or alternatively, e-commerce sites with stored registration & check-out data. The system can link to as many additional 1st or 3rd party databases as desired to add demographic data points and improve data quality. This principle is applicable to the collection of dwelling characteristic data as further described herein.

It should be understood that payment data, demographic data, dwelling data and/or energy consumption/utility usage data can be provided by the consumer or also received directly from a participating utility company, with the appropriate consents from the consumer.

The system server can generate an identifier that is unique to the particular consumer and the payment data, demographic data and any additional information determined therefrom can be associated with the consumer's identifier and stored in storage 190, preferably in database 185.

It should be understood that the consumer can also require authorization before the system server retrieves payment data and/or demographic information. Thus, it should be apparent that in the exemplary system and routine described herein, depending on applicable laws and regulations, a consumer can opt in, thereby consenting to the use of their transaction data as well as any other personal information he or she provides.

For situations in which the systems discussed here collect personal information about users, the users may be provided with an opportunity to control the manner such information is collected with respect to programs or features that may collect personal information (e.g., information about a user's demographic data, payment data or a user's current location/address). Users may also be informed of the accompanying limitations on the functionality of a service that may result from limiting access to such personal information. In addition, certain data may be anonymized in one or more ways before it is stored or used, so that personally identifiable information is removed. For example, a device identifier associated with a user's identity may be anonymized so that no personally identifiable information can be determined for the user, or a user's geographic location may be generalized where location information is obtained (such as to a city, zip code, or state level), so that a particular location of a user cannot be determined.

It should also be understood that the payment data, demographic data, and dwelling characteristic data, which is further described herein, can be retrieved prior to benchmarking and comparing the particular consumer's energy usage, dynamically when benchmarking and comparing usage or a combination of the foregoing.

Then, at step 310, processor 110 executing one or more of software modules 130, including, consumer analysis module 172, configures system server 105 to analyze the consumer's payment data and alternatively demographic data to identify the address of one or more dwellings for which the consumer makes energy payments. More particularly, by example and without limitation, the system server 105 can determine each dwelling address from such information as: an address associated with payments made to energy providers; a billing address associated with various payment methods (e.g., credit cards, bank accounts, contactless payments, ACH payments and the like); a most recent known address from a credit history report and the like or any combination of the foregoing. In addition, the address can be inferred by creating a purchase centroid of the consumer's transactions at merchants. Moreover, alternatively or in addition, an address can be identified by using a GPS location from the consumer's smartphone, using an IP address of a computing device being used by the consumer and/or matching the account information from a telecommunications/internet service provider to billing information on file.

It should be understood that the particular consumer can also manually provide an address for the consumer's dwelling as an alternative or to supplement or modify the address determined at step 310.

The remaining steps in this exemplary routine configures the processor to identify relevant, “look-a-like” comparison consumers, benchmark energy consumption, and compare the energy consumption of the particular consumer's dwelling to the benchmark energy consumption. “Look-a-like” comparison consumers are those that demographically match the particular consumer and make energy consumption payments for one or more “look-a-like” dwellings (a dwelling that matches the particular consumer's dwelling). The exemplary system and method is configured to account for the possibility that the particular consumer and one or more comparison consumers can make energy payments for multiple dwellings. As such, the ensuing steps can be performed for each dwelling identified at step 310. Similarly, the ensuing steps can also be performed for comparison consumers with one or more dwellings.

Then, at step 315, processor 110 executing one or more of software modules 130, including, preferably, database module 170, configures system server 105 to retrieve dwelling characteristic data relating to a dwelling address identified at step 310 from a data source that is independent of the payment database 103 or demographic database 104. More specifically, system server 105 can be configured by one of the modules or code to connect to dwelling characteristic database 102 and receive publicly available information pertaining to the dwelling address including dwelling data, location data and energy cost data.

Dwelling data can be obtained from, for example, historical and current state and county level building codes and certificate of occupancy metrics provided by various sources including public housing and inspection authorities, construction/development firms, real-estate companies and the like. Dwelling data can also be obtained from real-estate transaction records provided by housing authorities, real-estate companies (whether local or web-based) and the like as would be understood by those skilled in the art. Location data can include geographic information and regional weather data that can be obtained from weather and geographic information services. Energy cost data can include the rates charged by the energy providers that service the dwelling (e.g., electricity, natural gas and oil rates) and can be obtained from the energy providers or other energy rate reporting bodies. For the purposes of generating an energy consumption benchmark and comparing energy consumption of the particular consumer to the benchmark irrespective of energy provider and/or geographic location as further described herein, the processor is configurable to normalize the energy rates prior to the comparison using a conventional normalization function.

System server 105 can be configured using code executing in the processor to associate the consumer identifier with the information retrieved and otherwise derived in steps 310 and 315 and to store the information in storage 190 and/or database 185.

At step 320, processor 110 executing one or more of software modules 130, including, preferably, consumer analysis module 172, configures system server 105 to generate a profile for the consumer from the payment data, demographic data and dwelling characteristic data and to store the profile to storage 190 and/or database 185. More particularly, the system server is configured to compute and/or collect and process the following primary and secondary data points discussed next and assemble that information into a profile specific to the particular consumer and the dwelling. The profile can be associated with the consumer identifier and electronically stored in storage 190 and/or database 185.

The primary data points can include, for example: a year of construction of the dwelling; minimum insulation value of the dwelling; an average daily temperature where the dwelling is located; a size of the dwelling; a number of occupants of the dwelling; and the amount of one or more utility payments for the dwelling (computed by the consumer analysis module). The secondary data points can include, for example: one or more normalized energy rates for the dwelling; the particular consumer's age; the particular consumer's income; the age of one or more occupants who reside in the dwelling; and the particular consumer's education level. Other data points that can be included in the profile in addition to the foregoing include: the type of the dwelling (e.g., apartment, town-home, duplex, single family home, multi-family home, office building, factory and the like); presence of a photovoltaic system at the dwelling; presence of a pool at the dwelling; presence of air conditioning in the dwelling; heating fuel used by the dwelling; and whether the dwelling is used seasonally. In the case of a dwelling being a business location such as an office or factory, some additional or alternative data points can include: type of equipment located at the dwelling (e.g., manufacturing equipment); number of building occupants (e.g., number of employees, visitors or patrons); the type(s) of businesses in the dwelling and/or factory occupants. This information is largely collectable without requiring further computations; however the consumer analysis module 172 is operative, by the software code that comprises the module, to process these data points into a profile.

It should be understood that, alternatively or in addition, the particular consumer, using consumer device 101, can manually provide the system server 105 with demographic data, dwelling data and/or location data retrieved or generated at steps 310-315, or any of the data points determined at step 320.

At step 325, processor 110 executing one or more of software modules 130, including, preferably, consumer analysis module 172 and/or comparison module 174, configures system server 105 to compare the profile of the particular consumer to a relevant set of comparison consumers. The relevant set of comparison consumers includes one or more comparison consumers that are “look-a-likes” to the particular consumer (as defined above) and are identified from at least a database of payment data and a database of dwelling characteristic data. More particularly, the identifying step as can be implemented by the consumer analysis module includes applying an algorithm that, for each of the comparison consumers, compares one or more of the particular consumer's data points to a particular comparison consumer's one or more corresponding data points. The corresponding data points are determined from the particular comparison consumer's payment data, demographic data and dwelling characteristic data. The comparing step filters out or disqualifies/excludes the non-relevant (i.e., non “look-a-like”) comparison consumers and/or does not add them to the relevant set when the one or more corresponding data points does not match the one or more data points within a prescribed threshold value, range or the like.

In order to compare the data points from the particular consumer's profile to the comparison consumer's corresponding data points, the consumer analysis module 172 can be configured to operate upon less than a full profile for each of the comparison consumers, unlike the generation of a full profile when generating the particular consumer's profile. While a complete profile can be created for each comparison consumer (as in steps 305-320), this can be computing intensive and is not always necessary. As an alternative, the consumer analysis module 172 can selectively analyze portions of each particular comparison consumer's payment data, demographic data and/or dwelling characteristic data to ascertain the corresponding data points for comparison purposes and/or generate a partial profile. Selective analysis can minimize computing time or achieve other such efficiency goals as would be understood by those skilled in the art. Furthermore, the order in which data points are compared can be prioritized as a function of the relative ease with which the data point is ascertained, the likelihood that the data point will disqualify the particular comparison consumer or a combination of the foregoing. For example, data points that are more easily ascertained from the payment data, demographic data and/or dwelling characteristic data can be compared first. Alternatively, or in addition, data points that are more likely to disqualify the greatest number of comparison consumers such as, say, average daily temperature, can be compared first.

By way of further example, system server 105 can first review dwelling characteristic data to determine the zip-codes that have an average daily temperature, weather patterns and altitude that matches as the particular consumer's dwelling. System server 105 can then then review payment data to identify all the comparison consumers with a dwelling in the so identified zip-codes. Of this limited set of comparison consumers, the system can then do a further selective review of payment data, demographic data and/or dwelling characteristic data to identify those comparison consumers with a dwelling that is similarly sized to the particular consumer's dwelling and continue to step through the data points in the particular consumer's profile identifying one or more comparison consumers that have matching data points.

The method of determining whether a data point is a match to a corresponding data point can vary depending on the type of data point. For the data points that are defined by text or define a status of the consumer or dwelling, the data points can be required to match exactly, within prescribed criteria, such as falling within a set of pre-defined statuses. For example, status type data points include: dwelling type; consumer education level; type of heating fuel; presence of air conditioning; presence of children in the dwelling and the like. For example, a match can exist when the particular consumer's dwelling and the particular comparison consumer's dwelling is the same type (e.g., both dwellings are apartments) or are similar dwelling types (e.g., the dwellings are either a duplex or a townhome or multi-family home). Another example of a match is when the particular consumer's dwelling and the particular comparison consumer's dwelling both use the same heating fuel (e.g., they both use electricity to heat the dwellings). If a particular comparison consumer has a dwelling that uses oil for heat, then that particular comparison consumer is potentially not a match to a particular consumer who has a dwelling heated by uses electricity.

For the data points that are defined by a numerical value, a match can be found when the data points being compared match exactly or fall within a pre-defined range. Exemplary value type data points include without limitation: year of construction; minimum insulation value; average daily temperature; number of occupants; consumer age; consumer income and the like. For example, a match can be found when the size of a particular comparison consumer's dwelling is within 10% of the size of the particular consumer's dwelling. In another example, a match can be found when the average daily temperature of the consumer's dwellings being compared is within five degrees. In another example, a comparison consumer with a dwelling that has either, two, three, or four occupants can be a match if the particular consumer's dwelling has three occupants.

In addition, processor 110 executing one or more of software modules 130, including, preferably, consumer analysis module 172, can configure system server 105 to rank each of the comparison consumers in at least the relevant set by a relevance factor. The relevance factor can be computed by comparing one or more data points in the particular consumer's profile to the corresponding data points for each of the comparison consumers in at least the relevant set. The relevance factor can be determined on a data point by data point basis, and can also be calculated on an overall basis. It should be understood that the various data points used to determine whether a comparison consumer is a “look-a-like” can vary in importance, and as such, the relevance factor of the various data points can be weighted accordingly for the purposes of calculating the overall relevance factor of a particular comparison consumer.

Furthermore, it should be understood that, in the event that one or more data points cannot be identified from the review of payment data, demographic data and dwelling data or otherwise supplied by the consumer, the processor can nonetheless substitute the unknown data point with a data point estimated from otherwise similar consumers, use an arbitrary data point as a placeholder and/or adjust or discount the relevance factor associated with the data point as a result of the substitution or estimation.

The process of identifying the “look-a-like” comparison consumers and adding the comparison consumers to the relevant set can be performed iteratively until all “look-a-like” comparison consumers are identified. Alternatively the system can iterate until at least a desired number of “look-a-like” comparison consumers are identified or a desired number of comparison consumers having a relevance factor that is above a pre-determined threshold is reached. If the relevant set does not include the desired number of comparison consumers, the system can repeat the process of identifying relevant consumers by selectively relaxing the standards used to determine whether a data point is a match until the desired number of “look-a-like” comparison consumers is identified. It should be understood that the standards and/or which data points to consider in the comparison can be manually defined or adjusted by the particular consumer.

It should be understood that steps for identifying “look-a-like” comparison consumers can be broken into sub-routines that can be performed in any suitable order. For example, the system can first identify a set of comparison consumers that are demographically similar to the particular consumer by selective analysis of payment data and demographic data and then determine the relevant set by identifying the comparison consumers with “look-a-like” dwellings. Alternatively the system can first identify a set of “look-a-like” dwellings and then determine which of the comparison consumers are demographically similar.

Then, at step 330, processor 110 executing one or more of software modules 130, including, preferably, comparison module 174, configures system server 105 to determine a benchmark energy consumption as a function of the energy consumption of the comparison consumers in the relevant set for a given time period. Determining the benchmark energy consumption includes applying an algorithm that, for each of the comparison consumers in the relevant set, calculates the energy consumption of the particular comparison consumer in the relevant set from the particular comparison consumer's payment data (e.g., the history of payments made to energy providers) and dwelling characteristic data (e.g., energy cost data or the rate at which the energy was provided) for the given time period. The given time period can be defined by the particular consumer requesting the comparison services or a pre-set time period defined by the system server. For example, in one embodiment, processor 110 can determine the benchmark energy consumption using a linear regression, multiple regression, multivariate regression and/or logistic regression on the complete population using the payment data and dwelling data to produce a regression equation/model. This regression could similarly be used for a subset of the population restricted by geographic or demographic factors to enable adapted model fit. Once built, the data for this specific dwelling/consumer can be entered into the equation as inputs with the benchmark energy consumption being the output. Alternatively, processor 110 can use the payment data and dwelling data as inputs to a neural network or machine learning model, thereby enabling non-linear estimation function of the benchmark energy consumption.

As discussed in relation to step 305, payment data can include, but is not limited to, the particular comparison consumer's transaction history using a variety of payment methods such as a credit card, a debit card, a prepaid card, a gift card, bank account billpay service or ACH payment or a combination of the foregoing. System server 105 can then analyze the transaction history to identify payments made to energy providers for the comparison consumer's “look-a-like” dwelling and the amount of any such payments. Energy cost data can include the rates charged by the energy providers that service the dwelling (e.g., electricity, natural gas and oil rates). For the purposes of generating an energy consumption benchmark and comparing energy consumption of the particular consumer to the benchmark irrespective of energy provider and/or geographic location as further described herein, the energy rates can be normalized as would be understood by those skilled in the art. It should also be understood that the energy consumption can be calculated for each type of energy resource (electricity, gas, oil) consumed by the dwelling.

Once the energy consumption for each of the comparison consumers in the relevant set is determined, the energy consumption can be benchmarked by, for example, calculating the average energy consumption of the relevant set of comparison consumers. As would be understood by those skilled in the art, the energy consumption benchmark can include any number of statistical or mathematical analyses such as mean, median, mode, standard deviation and the like. Furthermore, the benchmark can also be calculated or broken down as a function of the type of energy resource consumed, overall relevance factor or the relevance factor of a given data point.

It should be understood that the benchmark energy consumption can be determined for any number of past time periods, including without limitation, weekly, monthly, quarterly, yearly, etc. by aggregating the energy payments made for the given time period and the energy rates over the given time period. Similarly, the system can also identify whether a particular payment made or set of payments made is a full payment or partial payment and calculate total payments made for the given period accordingly.

In the event that energy payments for a “look-a-like” dwelling are shared by multiple comparison consumers, whether or not all are demographically matching, the system can aggregate the energy payments to determine the total energy payment amount for the dwelling's energy consumption for the given time period.

Then, at step 335, processor 110 executing one or more of software modules 130, including, preferably, comparison module 174, configures system server 105 to calculate the energy consumption of the particular consumer for the given time period. The energy consumption of the particular consumer can be calculated in the same manner that the energy consumption is calculated for each of the comparison consumers in the relevant set as discussed in step 330.

Then, at step 340, processor 110 executing one or more of software modules 130, including, preferably, comparison module 174, configures system server 105 to compare the energy consumption of the particular consumer calculated at step 335 to the benchmark energy consumption calculated at step 330 and generating an energy consumption report. The comparison can include mathematically determining the difference between the particular consumer's energy consumption and the average energy consumption of the relevant set. As would be understood by those skilled in the art, the particular consumer's energy consumption can be mathematically compared to any of the various benchmark energy consumption details in a variety of ways, including, but not limited to, calculating the difference as a function of normalized energy rates or non-normalized energy rates, type of energy resource, one or more data points, overall relevance factor or the relevance factor of one or more data points. In addition, the difference can be provided in percentages, dollar value and the like as would be understood by those skilled in the art.

The report can include, by example and without limitation, the particular consumers energy consumption and payment amount broken down by energy resource, the size of the relevant set of comparison consumers, the average relevance factor for the relevant set, the difference between the particular consumer's energy consumption and the average consumption of the relevant set, and the difference in payment amount (normalized and not-normalized). In addition, the report can also provide energy consumption and payment comparisons with those comparison consumers in the relevant set who have, for example: an overall relevance factor above a certain threshold; an average relevance factor for dwelling-related data points above a certain threshold; or an average relevance factor for demographic related data points above a certain threshold.

Then, at step 345, processor 110 executing one or more software modules 130, including, preferably, reporting module 176, configures system server 105 to provide the energy consumption report to the particular consumer. The energy consumption report can be printed and provided in paper form. Alternatively or in addition, the energy consumption report can be transmitted in an electronic format to the particular consumer 125 over the internet. For example, the report can be transmitted by e-mail or accessible by the consumer 125 using consumer device 101 through a portal or dashboard operated by system server 105. In addition, the report can be provided to a third party, such as a utility company or government entity.

In addition, processor 110 executing one or more of software modules 130, including, preferably, reporting module 176, can configures system server 105 to generate recommendations for the particular consumer as a function of the energy consumption comparison calculated at step 340. More specifically, depending on the particular user's energy consumption, say, if consumption is higher than the benchmark, the recommendations can include suggestions on how the particular consumer can alter their personal habits to conserve energy, goods or services to purchase in order to reduce energy consumption and provide information about tax credits for making improvements and the like.

Personal habit suggestions can include, say, turning off lights in rooms that are not in use or turning down the thermostat that controls heating by five degrees when the dwelling is unoccupied. Examples of recommended goods and services can include energy efficient light bulbs, smart thermostats, and increasing insulation “R Value” by installing supplemental insulation. In addition, the recommendations can also provide a list of one or more online and/or local brick and mortar merchants who sell or provide the recommended goods or services and consumer reviews of the suggested goods or services and merchants. Such a list can be generated using internet search engines with access to such data or alternatively/in addition, the processor 110 can query the payment database 103 to identify transactions made with home-improvement merchants in a vicinity of the particular consumer's dwelling and identify the merchants from the payment records.

The system server 105 can also calculate the projected effect of each recommendation on the particular consumer's energy consumption from the particular recommendation's estimated or known effect on energy consumption and the particular consumer's energy consumption and provide the projected effect to the particular consumer.

The particular consumer can also be prompted to provide further details about the particular consumer or the dwelling being compared. This may be to clarify any inconsistencies in the information or data points gathered or generated by the system server in steps 305-345 or otherwise alter any of the data points, remove data points, or adjust the standards by which “look-a-like” comparison consumers are identified. Responsive to such an event, the system server 105 can repeat one or more of the steps and generate a supplemental comparison report.

At this juncture, it should be noted that although much of the foregoing description has been directed to systems and methods for benchmarking and comparing energy consumption, the systems and methods disclosed herein can be similarly deployed and/or implemented in scenarios, situations, and settings far beyond the referenced scenarios. It can be readily appreciated that the energy consumption benchmarking and comparison system 100 can be effectively employed in practically any scenario in which energy consumption can be measured, compared, benchmarked or otherwise predicted.

For example, the system for benchmarking and comparing energy consumption can also be used to predict the hypothetical energy consumption of a particular consumer and another dwelling, for example, a dwelling the particular consumer is interested in purchasing. Similarly, a utility could use the system to identify payment data from a single home and using multiple periods of payment history information to determine consumption/monthly usage fee at the look-a-like dwelling instead of visiting each dwelling to read the actual meter.

It is to be understood that like numerals in the drawings represent like elements through the several figures, and that not all components and/or steps described and illustrated with reference to the figures are required for all embodiments or arrangements.

Thus, illustrative embodiments and arrangements of the present systems and methods provide a computer implemented method, computer system, and computer program product for benchmarking and comparing energy consumption. The flowchart and block diagrams in the figures illustrate the architecture, functionality, and operation of possible implementations of systems, methods and computer program products according to various embodiments and arrangements. In this regard, each block in the flowchart or block diagrams can represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the present invention, which is set forth in the following claims.

What is claimed is:

1. A computer-implemented method for benchmarking and comparing energy consumption of a particular consumer having a profile, the profile including a plurality of data points relating to the particular consumer and the particular consumer's dwelling, to a relevant set of comparison consumers yet to be identified from a database of payment data and a database of dwelling characteristic data, comprising:
identifying the relevant set of comparison consumers, using the processor configured by code executing therein, wherein identifying includes applying an algorithm that, for each of the comparison consumers, compares one or more of the particular consumer's data points to a particular comparison consumer's one or more corresponding data points determined from at least the database of payment data and the database of dwelling characteristic data and adds the particular comparison consumer to the relevant set when the one or more corresponding data points match the one or more data points;
determining a benchmark energy consumption using the configured processor; wherein determining the benchmark energy consumption includes applying an algorithm that, for each of the comparison consumers in the relevant set, calculates the respective energy consumption using the database of payment data and the database of dwelling characteristic data;
calculating, with the configured processor, the particular consumer's energy consumption using the database of payment data and the database of dwelling characteristic data; and
generating, with the configured processor, an energy consumption report, by applying an algorithm that compares the particular consumer's energy consumption to the benchmark energy consumption; and
providing the energy consumption report to the particular consumer.

2. The method of claim 1, wherein the steps for generating the particular consumer's profile includes:
retrieving, using the processor configured by code executing therein, the particular consumer's payment data from the payment database over a computer network;
retrieving, using the configured processor, the particular consumer's demographic data;
analyzing, using the configured processor, the payment data or the demographic data to identify an address for the dwelling;
retrieving, using the configured processor, dwelling characteristic data over a computer network from the dwelling characteristic database, the dwelling characteristic data including dwelling data, location data and utility rate data; and
analyzing, using the configured processor, the payment data, the demographic data and the dwelling characteristic data in order to identify the plurality of data points and create the particular consumer's profile.

3. The method of claim 1, wherein the plurality of data points includes: a year of construction of the dwelling, minimum insulation value of the dwelling, an average daily temperature where the dwelling is located, a size of the dwelling, a number of occupants of the dwelling, and one or more utility payment amounts for the dwelling.

4. The method of claim 3, wherein the plurality of data points also includes: one or more normalized energy rates for the dwelling; the particular consumer's age, the particular consumer's income, an age for one or more occupants of the dwelling and the particular consumer's education level.

5. The method of claim 1, wherein the one or more corresponding data points are determined from the database of payment data, the database of demographic data and the database of dwelling characteristic data.

6. The method of claim 1, further comprising: generating a profile for the particular comparison consumer using the one or more corresponding data points.

7. The method of claim 1, further comprising: ranking the particular comparison consumer by a relevance factor using the configured processor, wherein the relevance factor is computed according to an algorithm that compares one or more of the particular consumer's data points to the particular comparison consumer's one or more corresponding data points.

8. The method of claim 1, further comprising: obtaining a permission from the particular consumer to retrieve the particular consumer's payment data and demographic data.

9. The method of claim 1, further comprising: obtaining a permission from the particular comparison consumer to retrieve the particular comparison consumer's payment data and demographic data.

10. The method of claim 1, further comprising: anonymizing the particular comparison consumer's payment data, demographic data and dwelling characteristic data.

11. The method of claim 1, wherein the payment data is a transaction history from the use of a credit card, a debit card, a prepaid card, a gift card, bank account billpay service or ACH payment or a combination of the foregoing.

12. The method of claim 1, wherein the demographic data is a credit history report.

13. The method of claim 1, wherein the dwelling characteristic data includes dwelling data, location data and utility rate data.

14. The method of claim 13, wherein the dwelling data includes a year of construction of a dwelling, minimum insulation value of the dwelling, size of the dwelling, number of occupants of the dwelling, the type of the dwelling.

15. The method of claim 13, wherein the location data includes geographic information at a location of the dwelling and weather data at the location.

16. The method of claim 15, wherein the geographic information includes an altitude, and wherein the weather data includes an average daily temperature.

17. The method of claim 13, wherein the utility rate data includes the rates at which one or more utility providers provides energy resources for a dwelling.

18. A system for benchmarking and comparing energy consumption of a particular consumer to a relevant comparison consumers yet to be identified from a database of payment data, a database of demographic data and a database of dwelling characteristic data, the system having one or more processors configured to interact with a computer-readable storage medium and execute one or more software modules stored on the storage medium, comprising:
a database module configured to receive payment data from the database of payment data and demographic data from the database of demographic data over a computer network;
a consumer analysis module configured to, retrieve dwelling characteristic data relating to the particular consumer and analyze the dwelling characteristic data, payment data and demographic data in order to generate a profile including a plurality of data points relating to the particular consumer and the particular consumer's dwelling;
a comparison module configured to identify the relevant set of comparison consumers from at least the database of payment data; calculate the energy consumption for the particular consumer; calculate the energy consumption for the relevant set of comparison consumers; compare the energy consumption of the particular consumer to the energy consumption of the relevant set of comparison consumers; and
a reporting module configured to generate a comparison report and provide the comparison report to the particular consumer.
